(19) United States
(12) Patent Application Publication
(10) Pub. No.: US 2026/0304058 A1
(43) Pub. Date: Oct. 1, 2026

(54) SPATIAL AUDIO DIRECTING SYSTEM

(71) Applicant: Lenovo (United States) Inc., Morrisville, NC (US)

(72) Inventors: Mark Delaney, Raleigh, NC (US); Robert J. Kapinos, Durham, NC (US); John C. Mese, Cary, NC (US); Diana Gerli, Raleigh, NC (US); Nathan Peterson, Oxford, NC (US)

(21) Appl. No.: 19/094,155

(22) Filed: Mar. 28, 2025

(51) Int. Cl. H04S 7/00; G06F 3/01

(52) U.S. Cl. CPC H04S 7/303; G06F 3/013; H04S 2400/11

(57) ABSTRACT

One embodiment provides a method, the method including: receiving, at a spatial audio directing system, an indication to output a sound at one of a plurality of audio output devices, wherein the sound is associated with content of an information handling device; determining, utilizing the spatial audio directing system, a location of the content on the information handling device and with respect to a position of the user; and outputting, utilizing the spatial audio directing system, the sound at an audio output device corresponding to the location of the content with respect to the position of the user. Other aspects are claimed and described.

### BACKGROUND

Viewing media on an information handling device via a display coupled to the information handling device is commonly accompanied by audio content. Since information handling devices are routinely used to perform functions to achieve an end goal, media supporting components, such as displays, speakers, and/or the like, are typically not of the highest-quality. In order to enhance a viewing and/or listening experience, a user may elect to attach additional media components of a higher quality. In doing so, an information handing device that may traditionally include a single display and minimal audio output devices (e.g., speakers integrally coupled to an information handling device), may then include multiple media component devices to choose from in order to achieve the highest-quality experience.

### SUMMARY

In summary, one aspect provides a method, the method including: receiving, at a spatial audio directing system, an indication to output a sound at one of a plurality of audio output devices, wherein the sound is associated with content of an information handling device; determining, utilizing the spatial audio directing system, a location of the content on the information handling device and with respect to a position of the user; and outputting, utilizing the spatial audio directing system, the sound at an audio output device corresponding to the location of the content with respect to the position of the user.

Another aspect provides a system, the system including: a processor; a memory device that stores instructions that, when executed by the processor, causes the system to: receive, at a spatial audio directing system, an indication to output a sound at one of a plurality of audio output devices, wherein the sound is associated with content of an information handling device; determine, utilizing the spatial audio directing system, a location of the content on the information handling device and with respect to a position of the user; and output, utilizing the spatial audio directing system, the sound at an audio output device corresponding to the location of the content with respect to the position of the user.

A further aspect provides a product, the product including: a computer-readable storage device that stores executable code that, when executed by a processor, causes the product to: receive, at a spatial audio directing system, an indication to output a sound at one of a plurality of audio output devices, wherein the sound is associated with content of an information handling device; determine, utilizing the spatial audio directing system, a location of the content on the information handling device and with respect to a position of the user; and output, utilizing the spatial audio directing system, the sound at an audio output device corresponding to the location of the content with respect to the position of the user.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for outputting sound at an audio output device corresponding to the location of content with respect to the position of the user by use of a spatial audio directing system.

FIG. 4A illustrates an example system setup utilizing spatial audio techniques associated with a secondary display located to the left of an original information handling device.

FIG. 4B illustrates an example system setup utilizing spatial audio techniques associated with a secondary display located to the right of an original information handling device.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

A system that includes at least one display and at least one audio output device coupled to an information handling device traditionally follows a predetermined ruleset, configuration, and/or the like, when directing audio media to an output for a user to hear. Content consumed by a user commonly includes both visual media data and audio media data. Upon selection of a piece of content, a system may display the visual media data on a display coupled to an information handling device for a user to view. In a system that includes more than one display and/or a display that may be segmented into sections, a user may be permitted to alter a position, and/or location on a display, of the content being viewed. For example, in a system that includes two displays operatively coupled together, a user may elect to move an application window from one display to the other. In doing so, a user may have to adjust their position to more comfortably view the content now present on the other display. Traditionally, a user may make these application position alterations; however, audio media data associated with the same content may be provided from the same source, and/or in the same direction, regardless of the location of the content being viewed.

In a traditional system, when supplying sound, and/or audio media data, from an audio output device of an information handling device, the system may follow a system design, component relationship, and/or the like, that may provide sound in the same way and along the same direction no matter where the content is being viewed. This lack of dynamic adjustment of sound providing for a device commonly results in a negative user experience when consuming content because when parts of content (e.g., visual media data and audio media data) are supplied in different locations, a user may struggle to hear and/or see what is accompanying the alternate part of the content. Therefore, what is needed is a system and method that can determine a location of content present on a display coupled to an information handling device, and then determine at least one audio output device present at a location that is consistent in an output direction with the display to supply the content to the viewer. In finding an audio output device that is consistent in direction with a display being viewed, audio media data may be consumed in a direction relative to a user position at the device, and may further provide the highest-quality viewing experience of the content.

Accordingly, the described system and method provides a technique for outputting sound at an audio output device corresponding to a location of the content with respect to the position of the user by use of a spatial audio directing system. An information handling device comprising at least one display receives an indication to output sound associated with content being viewed by a user to the user. The content being displayed on a display device of the information handling device may be contained within a window of an application that is present within the information handling device. A spatial audio directing system of the information handling device may then determine, from the indication received, a location of the content being viewed by the user. The spatial audio directing system may utilize one or more position-tracking methods to determine where an application is being displayed. An information handling device may include at least one display for displaying content. Such an information handling device is not limited to the use of only one display, therefore, determining a location of the content may include determining which display, in a system comprising multiple displays, includes the application being viewed by a user. Additionally, the spatial audio directing system that is determining the location of the content may further determine a viewing direction associated with the location of the content with respect to an original display of the information handling device.

Then, based upon the determined location of the content being viewed by the user and utilizing the spatial audio directing system, the system may provide the sound associated with the content to the user by use of at least one audio output device. The location of the content being viewed by the user may instruct the spatial audio directing system towards at least one audio output device (e.g., speaker) that may provide the highest-quality audio experience. Rather than being restricted to receiving audio from a standard audio output device arrangement, the spatial audio directing system may determine at least one audio output device at a location consistent with the location of the display providing content to ascertain the clearest supplying of audio of the content to a user. Additionally, if a user adjusts their position while viewing content and/or the location of an application supplying content from a display to an alternate display, the spatial audio directing system may transition between audio output devices in order to continuously provide high-quality audio for the content being viewed.

Such a system and method provide techniques over traditional audio outputting methods that are restricted to standardized production based upon an audio output device present at an information handling device. Being limited to continuously outputting audio from a stationary location while content being viewed is positioned at the highest-desirable location on an information handling device often results in frustrated viewership of content and poor ergonomic design. Therefore, the system and method described herein outputs sound data associated with visual content on a display from a direction consistent with the location of a display, and provides a necessary improvement over traditional sound outputting systems and methods.

The illustrated example embodiments will be best understood by reference to the figures. The following description is intended only by way of example, and simply illustrates certain example embodiments.

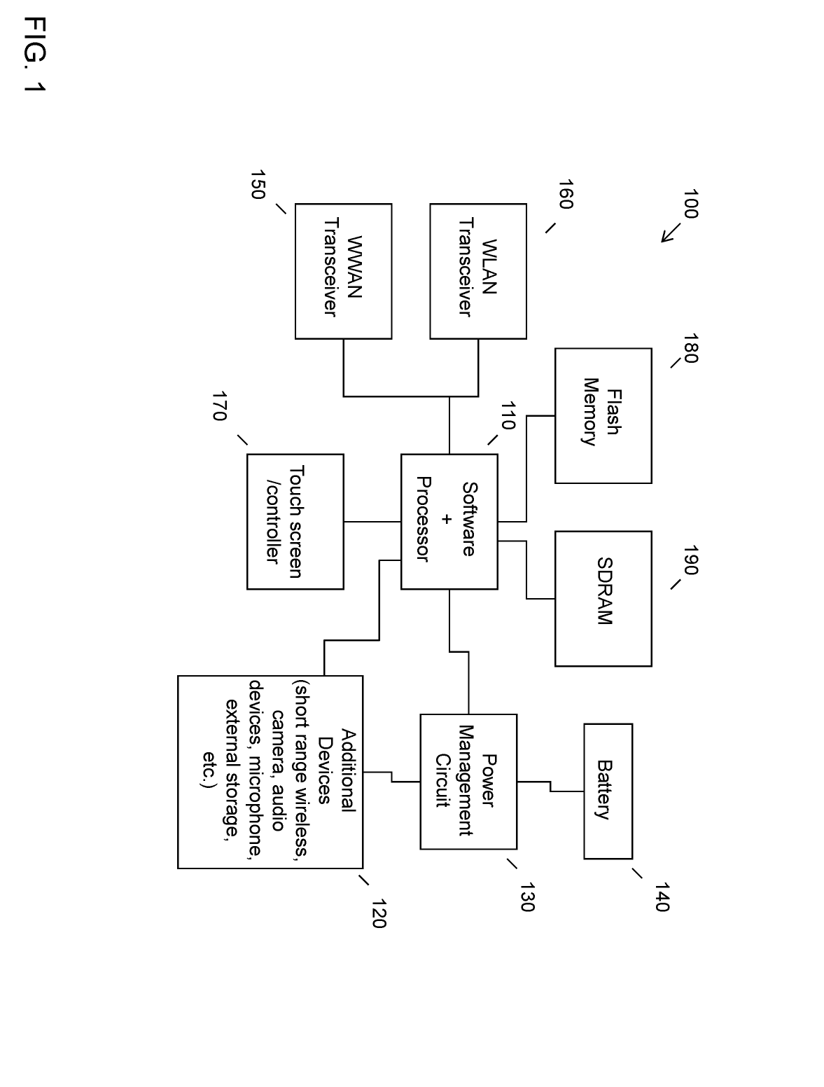

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

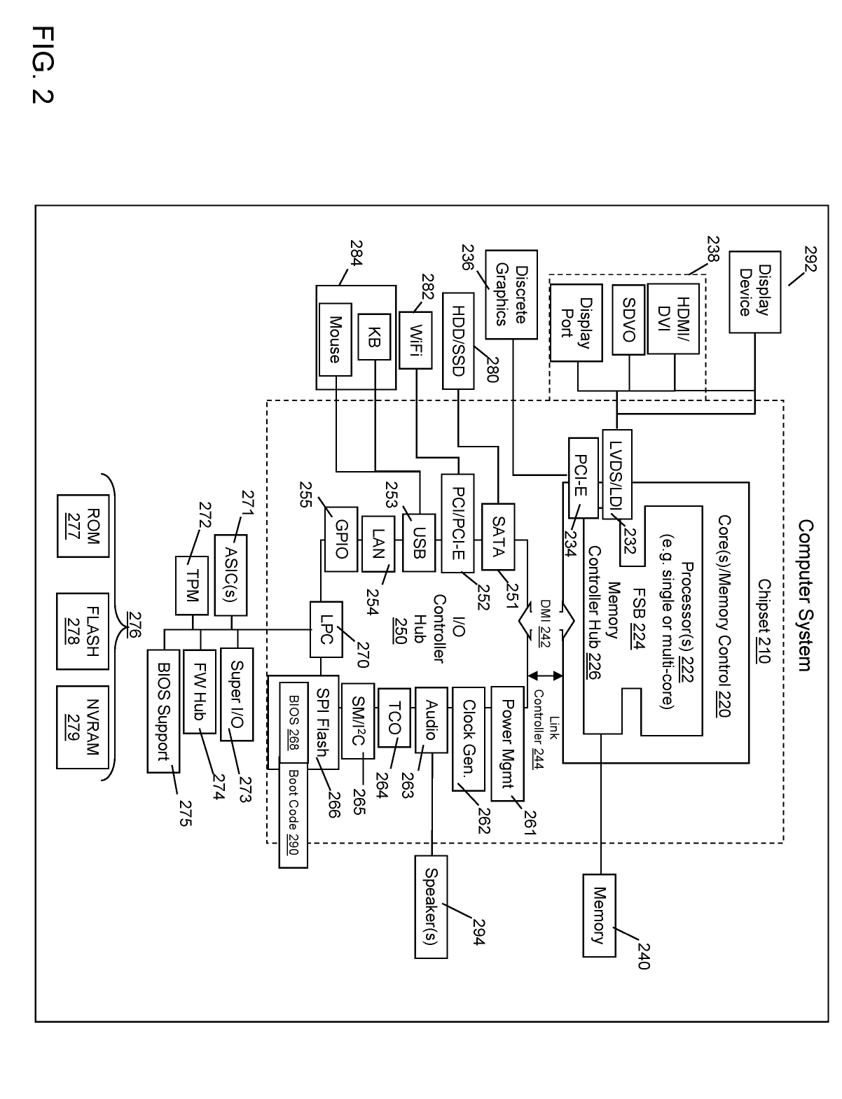

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used in devices or systems associated with servers and networks to which servers may be added or provisioned and devices or systems that may assist in outputting sound at an audio output device corresponding to a location of content with respect to a position of a user. For example, the circuitry outlined in FIG. 1 may be implemented in a tablet or smart phone embodiment, whereas the circuitry outlined in FIG. 2 may be implemented in a personal computer embodiment.

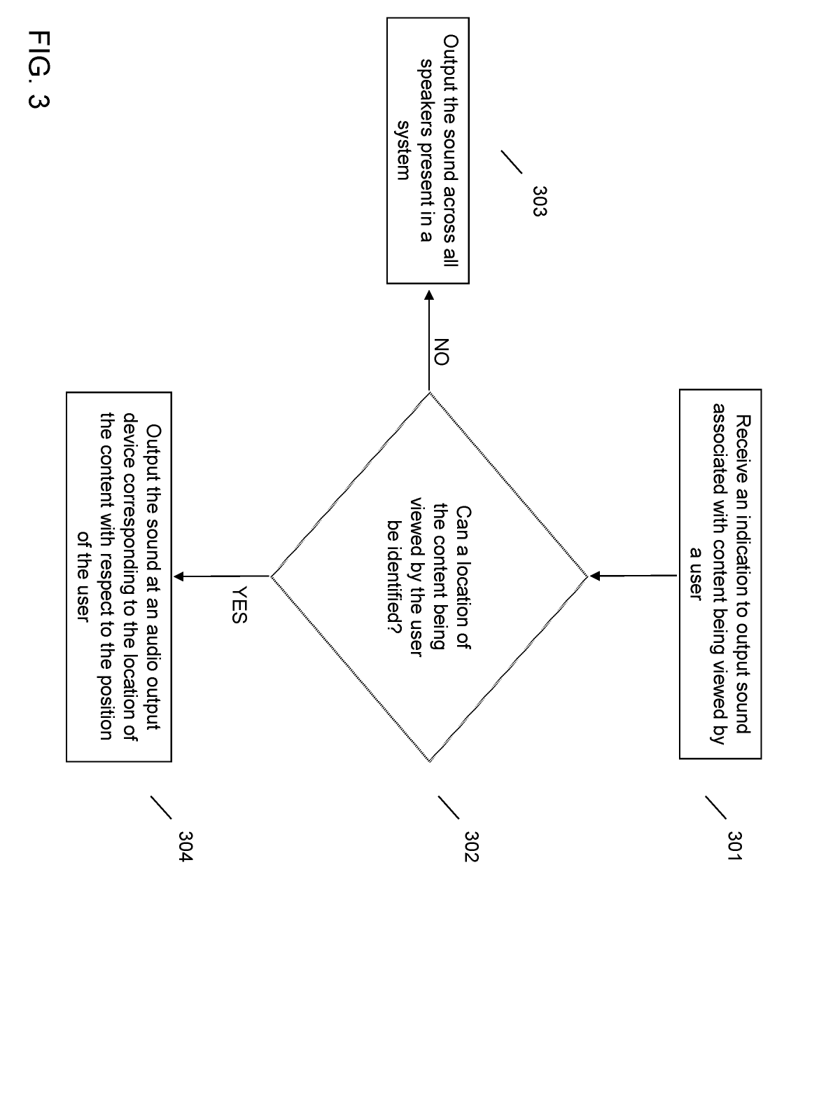

FIG. 3 illustrates an example method for outputting sound at an audio output device corresponding to the location of content with respect to the position of the user by use of a spatial audio directing system. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIGS. 1 and/or 2. While the system may include known hardware and software components and/or hardware and software components developed in the future, the system itself is specifically programmed to perform the functions as described herein to output sound at an audio output device associated with content to a user from a direction consistent with the location of a display and with respect to a position of a user while utilizing an information handling device. Additionally, the spatial audio directing system includes modules and features that are unique to the described system.

The activation of the spatial audio directing system may be manual, where a user provides an input indicating that the spatial audio directing system should be activated, or automatic where the spatial audio directing system detects a trigger event indicating that the system should be activated. Example trigger events include detection of a user input for activation of an application stored within an information handling, instruction to output audio media data of content currently being provided, the receipt of a notification accompanied by a notification chime, and/or the like. For example, the system may identify that a user has activated an application of a video streaming service that upon activation provides a notification chime, and further audio media data is provided alongside visual media data upon selection of a video. This received user input and/or automatic notification chime may be considered a trigger event that activates the spatial audio directing system.

The spatial audio directing system may be a standalone system, may be accessible through other computing devices, and/or a combination thereof. For example, the spatial audio directing system may be a standalone system that can be accessed by a user and/or may be or provide an application that is accessible by a user on another computing device. The spatial audio directing system may be accessible using any type of computing device, for example, personal computer, laptop computer, smartphone, tablet, smartwatch, head-mounted display, smart television or other smart appliance, augmented reality device, virtual reality device, and/or the like. Thus, the spatial audio directing system may be accessible locally using a computing device where the spatial audio directing system is installed and/or may be accessible remotely through another computing device. For example, the spatial audio directing system may be accessed by a user who has provided direct input into a system associating an audio output device to a display. However, the spatial audio directing system may be located and operate on a different information handling device to perform the described steps.

The spatial audio directing system may have an associated graphical user interface. The graphical user interface may be provided on a display or monitor, which may or may not be associated with the spatial audio directing system. In other words, the spatial audio directing system may have a dedicated display or monitor or may be accessible using any display or monitor. In either case, the spatial audio directing system may provide instructions to generate and display the graphical user interface on the display device being used to access the spatial audio directing system. The graphical user interface may also be updated and managed based upon instructions provided by the spatial audio directing system. In other words, the spatial audio directing system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the spatial audio directing system. For example, the spatial audio directing system may utilize a predetermined list of audio output device locations and relationships between peripheral devices coupled to an information handling device. The graphical user interface may allow for a user to provide input to the predetermined list of audio output devices, adjust device relationships between displays and audio output devices, and/or the like. The graphical user interface may also allow a user to input decisions to be made by the spatial audio directing system in real-time. The user may also provide information or notes in relation to an alert or notification through the graphical user interface.

Within the graphical user interface, the user may also identify, select, remove, and/or otherwise modify devices that may be utilized to determine locations and/or positions of peripheral devices in relation to an origin device, and a user position. The user may also access information related to these devices, for example, information identifying device identifiers, device components or sensors, the location of the devices, and/or the like.

The graphical user interface may also outline displays that present information from an application on an information handling device, and/or the like. It should be noted that the information to be used by the spatial audio directing system and information provided by the spatial audio directing system can be different for different applications, different computing systems, different users, and/or the like. Thus, the information corresponding to input or output of the spatial audio directing system are not always the same. However, the spatial audio directing system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The spatial audio directing system may utilize one or more artificial intelligence models in determining audio output devices to be used in combination with at least one display to provide the highest-quality viewing experience, determine a location of all audio output devices and displays of an information handling device, and determine a user attention for user positing data. Artificial intelligence models may also be used for steps within a step. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the spatial audio directing system or may be a model that is created from scratch. Since the spatial audio directing system is used in conjunction with user position detecting and audio output device tracking, some models that may be utilized by the system are image analysis models, entity identification models, similarity identification models, analysis models, filtering models, classification models, and/or the like. The model may be trained using one or more training datasets. Additionally, as the model is deployed, it may receive feedback to become more accurate over time. The feedback may be automatically ingested by the model as it is deployed.

On the other hand, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The spatial audio directing system may include different components for carrying out different functions of the system, including different steps to be performed. These components may be hardware components or software components. Some hardware components may include image capture sensors, audio capturing sensors, and/or the like. The image data can be utilized to perform the determining of locations for audio output devices, display devices of an information handling device, a position of a user utilizing a device and/or viewing content, and/or the like. This is in contrast to traditional sound mapping that operates solely based upon a relationship, and/or coupling, of a device to a system that includes at least one audio output device. However, the traditional sound mapping, routing, directing is unable to determine a location of the content being viewed by the user to then determine the most appropriate audio output device to provide audio media data. Thus, if there’s a change in position content on a display, a traditional method will not adjust audio outputting devices.

However, in order to perform sound directing to the correct audio output device, the spatial audio directing system needs to capture image data for a system. There are many different devices or systems that can be utilized that can capture either image data. Some example systems or devices that may be utilized include, but are not limited to, surveillance cameras, smart phones, augmented reality devices, virtual reality devices, three-dimensional cameras, and/or the like. Performing the sound directing for content being viewed by a user may be assisted utilizing one or more artificial intelligence models.

From the behaviors of the user while operating an information handling device, particularly over time, the spatial audio directing system can identify patterns of a user while in use of the device. Thus, from the behaviors captured during the training, the system may analyze the behaviors to identify patterns of the user while using a device. Accordingly, from the captured behaviors, the system can identify the patterns of the user and from these patterns can create a behavior profile of the user while utilizing a device. Accordingly, the behavior profile of a user is very complex and may take into account many different factors, objects, and/or the like, to accurately reflect the behavior of the user while operating a device.

Artificial intelligence models can be used when directing sound, and/or audio media data, to an audio output device consistent with a display providing visual media data of a piece of content. Artificial intelligence models can also be used in the capturing of the user behavior while operating a device. For example, the models can be used to analyze the behaviors of the user to generate a behavior profile of the user and then used to create a profile of the user from the behavior profiles. Additionally, or alternatively, the artificial intelligence models can be used to perform other steps, assist in performing some of the steps, and/or the like.

At 301, the system may receive an indication to output sound associated with content being view by a user at an information handling device comprising at least one display. An active information handling device comprising a plurality of applications may display an application in use on a display coupled to the information handling device. The information handling device may include a single display for displaying an application and/or an application window. A single display of an information handling device may be of a traditional size and maybe coupled to the information handling device in one of a variety of ways, for example, a display may be integrally coupled to an information handling device (e.g., a laptop), a display may be operatively coupled to an information handling device (e.g., an external monitor), and/or the like. A display operatively coupled to an information handling device may be paired to an information handling device using a wire and/or wirelessly. Additionally, and/or alternatively, an information handling device coupled to a single display may include coupling the device to an oversized display. In such a system, an oversized display may reference any display that is larger than a traditional display of an information handling device, for example, any display with a size greater than 24-inches.

Additionally, at least one display paired to an information handling device may encompass embodiments that include a plurality of displays connected to an information handling device. In other words, information handling device setups that include two or more displays coupled to a device are permitted. An application, and/or an application window, presented on a display of an information handling device may include content viewed by a user. The content being viewed by the user includes visual media data supplied from an active application of the information handling device. A plurality of accessible applications may be provided to a user, and based upon an application activated by the user, content including visual media data may be displayed on a display of at least one display coupled to the information handling. An application supplying content being viewed by a user may be located on a display, and/or a single display in a system setup containing multiple displays, coupled to an information handling device.

As a display of an information handling device is presenting content associated with an active application and within an application window, the system may receive an indication to output sound associated with the content being viewed by a user 301. The content of an application may include both visual media data and audio media data. Therefore, when receiving an indication to provide sound associated with content being viewed 301, the system may activate audio media data associated with the visual media data of the content. An indication that is received includes receiving a user input at the content, and/or the application housing the content, to provide audio media data. For example, an indication may include selecting “play” on a streaming application, unmuting previously silenced audio media data at a graphical user interface of an application, transitioning content types from a piece of content that was strictly visual content to content that includes both visual media data and audio media data, and/or the like. Additionally, and/or alternatively, an indication received to output sound 301 may occur upon the activation of an application. For example, upon receiving a user input at an information handling device selecting a video on a streaming application, audio media data associated with visual media data may be supplied automatically and at the same time as the visual media data. In other words, receiving an indication to output sound associated with content being viewed 301 may occur at any time that visual media has been selected and/or is currently being provided to a user.

Subsequent to receiving an indication to output sound associated with content being viewed by a user on display coupled to an information handing device, the system may determine if a location of the content being viewed by the user can be identified 302. A spatial audio directing system of an information handling device may collect location data of an application providing the visual media data to a user. Location data of an application may describe a display that a user is viewing the content of an application on. In a system including a single display device, the spatial audio directing system may determine that there is one location for the content to be displayed for a user to view. Additionally, and/or alternatively, in a system including multiple displays, the spatial audio directing system may determine which display of the multiple displays presents the content being viewed by the user. The display that contains the content is then determined to be the location of the content being viewed by the user. Additionally, and/or alternatively, the spatial audio directing system may determine that the content being viewed is spread across multiple displays coupled to the information handling device. In such a scenario, the spatial audio directing system may record the location of the content as being present on each device utilized in combination that is displaying the content being viewed by a user.

Additionally, in using a device that includes a single display, the spatial audio directing system may determine a more specific location of content being displayed based upon a determined section of a display that the content is present within. A display may be portioned into equal sized sections, and content that is positioned into one of these sections may provide location data to the spatial audio directing system describing where on the single display the content is being displayed. For example, a display may be sectioned in halves, therefore, when the content is being provided within one of the two sections that a display is sectioned into, the spatial audio directing system can track this more specific location that may then be utilized when providing spatial audio back to the user viewing the content. Additionally, and/or alternatively, for example, a display may be sectioned into four equal sized quadrants that may also provide a more detailed description of a location of content presented on a display. Segmenting a display into at least two sections can be performed on a display of a traditional size and/or on an oversized display. In a device setup including an oversized display, a number of sections that a display is segmented into is not limited to, for example, 2 or 4 sections. In other words, an oversized display may be segmented into a plurality of sections as long as the sections are equal in size.

Determining a location of the content being viewed by the user 302 from the received indication 301 and utilizing a spatial audio directing system of the information handling device may include utilizing at least one sensor operatively coupled to the information handling device to collect user position data. An information handling device may be previously paired with at least one sensor, for example, an image capturing device (e.g., an external camera, a front-facing camera, etc.), a positioning device (e.g., an infrared device, radar device, etc.), an audio capturing device (e.g., a microphone, etc.), and/or the like. The information handling device may collect data from the at least one sensor describing a position of a user that is using the information handling device, and may then share this information with the spatial audio directing system of the information handling device to determine how a user is ingesting content present on a display. The spatial audio directing system may utilize the user position data collected in combination with the determined location of content being viewed by the user 302 to then determine which audio output device(s) (e.g., speakers) should output the sound of the content to the user 304.

The spatial audio directing system may utilize an artificial intelligence model and associated methods to assist with determining a position of a user viewing content presented on a display of the system. For example, an artificial intelligence model of the spatial audio directing system may utilize a gaze-detection method to determine a direction of a user’s gaze. Such gaze-detection data collected by at least one sensor and processed by the spatial audio directing system may then determine a direction for supplying sound, and/or audio media data, of the content to the user viewing the content. An artificial intelligence model of the spatial audio directing system is not limited to the utilizing a gaze-detection method and/or image data collected by an image capturing device. This is intended as a non-liming example. Additionally, any positioning data that may be collected and manipulated by an artificial intelligence model of the spatial audio directed system is permitted, for example, the use of an audio capturing device may collect user voice data in a manner that may determine a user orientation while operating an information handling device.

When determining if a location of the content being viewed by user can be identified 302 the spatial audio directing system may determine a direction for outputting the sound associated with the content being viewed by the user. A direction for providing the sound describes which audio output device(s) may provide the sound to a user to promote the highest-quality viewing experience. An information handling device may include at least two sets of audio output devices (e.g., speakers) integrally coupled to the information handling device. Additionally, and/or alternatively, an information handling device may be coupled to at least one external audio output device. In other words, a number of audio output devices may be coupled to an information handling device and based upon the determined location of the content being viewed by the user and user position data collected by the system, the spatial audio directing system may determine which of audio output devices may provide a user the audio media data associated with the visual media data that will promote the highest-quality viewing experience. In order to achieve the highest-quality viewing experience, audio media content may be outputted from at least one audio output device a location that is consistent with the location of the content being viewed by the user. This consistency across both audio media data outputting and visual media data supplying allows a user to ingest the content from a single direction. Rather than viewing content in one direction and receiving audio media data from a different direction, causing issues with hearing audio media data when viewing the content and/or not being able to view content while listening to audio media data outputted from a different direction, consistency with viewing content and hearing associated sounds of the content from the same direction ascertains a high-quality viewing experience. The spatial audio directing system operatively aligns the devices (e.g., displays and audio output devices) to assure that the portions of content taken in by a user are provided from the same, and/or the most appropriate, direction.

As the spatial audio directing system of an information handling device is utilized to determine a location of the content being viewed by the user 302 and also to determine a direction for outputting sound associated with the content being viewed by a user, the system may track a location of each of the at least one audio output devices coupled to the information handling device. An information handling device traditionally includes at least one set of speakers. These two speakers may be located at opposite sides of an information handling device and integrally coupled to the device. For example, a traditional laptop computer includes a speaker located on each side of the keyboard that are built into the laptop casing. Determining a location of each audio output device coupled to an information handling device assists with determining a direction for outputting sound associated with content being viewed by a user. Then, as a spatial audio directing system is determining the most appropriate audio output device to supply audio media data of the content, the system may compare a determined location of a display presenting the visual media data of the content to a location of each audio output device available to provide audio media data of the content. The spatial audio directing system may then determine that at least one speaker coupled to a device is located at a position consistent with the display presenting the content. As mentioned previously, directing visual media data and audio media data from a display and at least one speaker in a consistent direction to a user will provide the best experience. A display of an information handling device and an audio output device may be located at the same location. The same location may include the display and audio output device being within threshold distance from each other, for example, being within a one-foot radius of each device.

Additionally, and/or alternatively, a display of an information handing device and an audio output device may be located at offset positions from one another, for example, outside a predetermined threshold distance. Even when a display presenting visual media data and an audio output device are present at offset locations, the display and the audio output device may be considered to be in consistent direction for providing both pieces of media data when outputting content to a user. Determining a display and at least one audio output device are present in a consistent direction with respect to a user even when a display and the at least one audio output device are in offset positions is based upon the most appropriate direction for supplying the portions of media data to the user. A spatial audio directing system may weigh a location of all available audio output devices in relation to a display presenting content and a user position, and when all audio output devices are determined to at an offset position from the display, the spatial audio directing system may determine at least one audio output device that comprises the most appropriate direction, and/or a direction most closely related to a consistent direction, for outputting audio media data of the content on a display to the user.

In other words, if a distance between offset devices, both a display and an audio output device, are great enough to consider that each audio output device is orientated in a different direction than the direction a display is presenting content to a user, then the spatial audio directing system may determine that supplying of visual media data and audio media data is inconsistent, and therefore, a lower-quality viewing experience may be outputted. When it is determined that a direction for output is inconsistent, a system may output a sound across all speakers present in a system 303, as if operating under a traditional system and method for outputting audio at a device.

In addition to determining a location of at least one audio output device for potentially outputting audio media data to a user, the spatial audio directing system may account for a how an audio output device is orientated in regard to audio projection direction. A location of an audio output device may be determined to be consistent with a display providing content; however, an actual outputting portion of the audio output device may be orientated away from the user. In such a system, if sound were to be provided to a user, the sound may be projected in an opposite direct than the content is being displayed, thus, away from the user viewing the content. A spatial audio directing system may determine the orientation for audio projection of each audio output device coupled to an information handling device when determining a location of the content being viewed by a user 302 and therefore, determining at least one audio output device to provide audio media data of the content to the user.

A setup that includes a display presenting content that requires an audio output device may include an audio output device at an offset location and orientated towards a user over an audio output device that is present at the same location but determined to be orientated in an opposite direction of the user. Receipt of the content from a display device and an audio output device is desired to be provided with the highest-quality viewing experience. The spatial audio directing system of an information handling device may utilize an artificial intelligence model to assist with determining the best combination of at least one audio output device and a display of an information handling device in order to provide the greatest viewing experience.

In determining if a location of the content being viewed by the user can be identified 302, identifying a display of an information handling device presenting the content, and thereafter, determining at least one audio output device in a consistent direction with the display and orientated towards a user, as established by the user position data, a spatial audio directing system may determine that an audio output device is not present at an appropriate location in comparison to the display. In other words, the direction for outputting media between a display and at least one audio output device is inconsistent. Therefore, since a location of the content being viewed by the user cannot be fully identified, the system may output the sound across all speakers present in a system 303. In other words, all speakers coupled to an information handling device and active may provide audio media data, and/or sound(s), when instructed. Utilizing all speakers simultaneously is a traditional method for providing audio media data to a user.

However, when a location of the content being viewed by the user can be identified 302 in its entirety, the spatial audio directing system may output the sound, and/or audio media data, associated with the content to the user by use of at least one audio output device 304. The spatial audio directing system may provide content to a user in a consistent direction based upon a position of a user utilizing an information handling device. Thus, when outputting the sound associated with the content to the user 304, the spatial audio directing system may determine which audio output device, and/or combination of audio output devices, may establish the consistent direction for outputting audio media data based upon user position data viewing visual media data at a display of an information handling device, and therefore, providing the highest-quality viewing experience.

The following are examples of system setups and describe how a spatial audio directing system may compare device locations in order to determine the best audio output device for supplying audio media data associated with a display providing content to a user. These examples are non-limiting and are included to assist with understanding the system and methods disclosed in this specification.

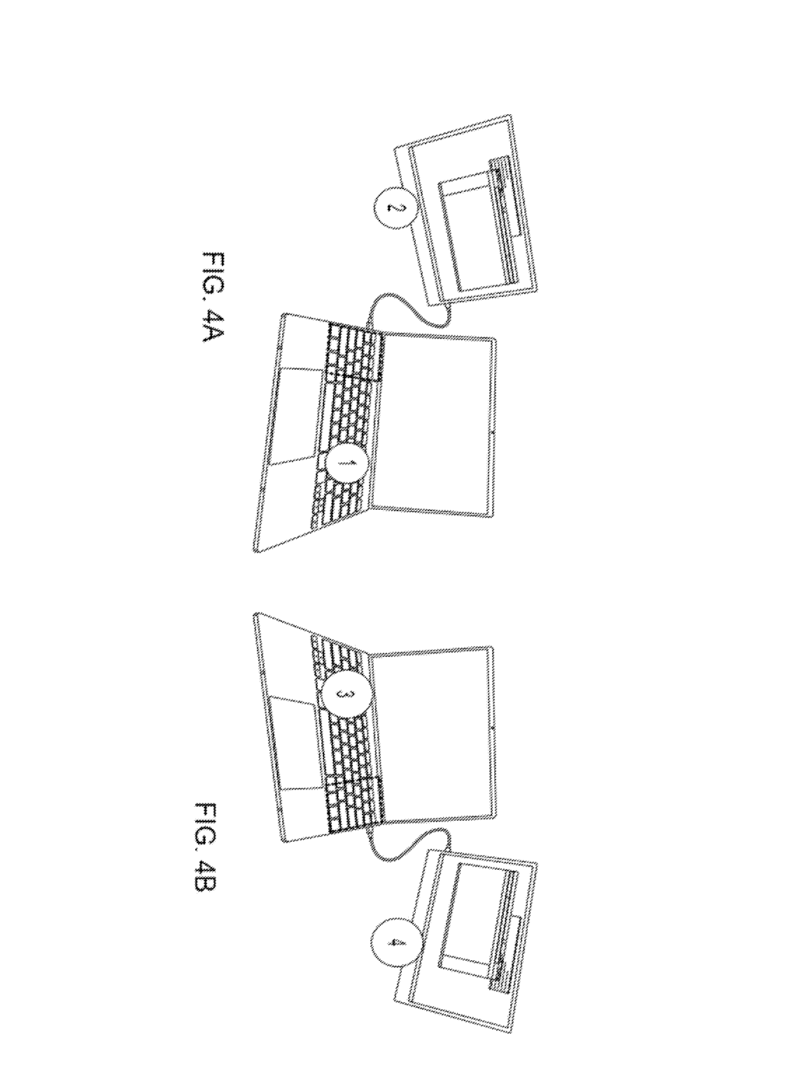

Referring now to FIG. 4A, a system including two monitors and a traditional laptop speaker setup is provided. In this system, a laptop “1” may include a display integrally coupled to the system and a traditional speaker setup also integrally coupled to the system. This speaker setup includes at least one speaker present on the left and right sides of the keyboard. In this system, an external monitor “2” in operatively coupled to the laptop 1. Upon connection of the external monitor 2 to the laptop 1, a spatial audio directing system may receive external display data and may further determine a location of the external monitor 2 in comparison to the laptop 1, and/or an origin device. The spatial audio directing system may determine that the external monitor is located to the left of the laptop 1.

A user may then access a virtual meeting through an application present on the information handling device. After activating an application on the laptop 1, the application may open on the display of the laptop 1. At this instance, the spatial audio directing system may determine that any audio media data associated with content being viewed, for example, the virtual meeting application, may be supplied in a traditional manner from both speakers present on each side of the laptop 1. Here a user’s attention is determined to be directed to the display of the laptop 1. Then, as a user transitions a location of the application of the virtual meeting from the display of laptop 1 to the external monitor 2, the spatial audio directed system may determine that a location the content has been repositioned and user position data has been adjusted because the repositioning of content to a new display. In response to this transition of location of content, the spatial audio directing system may determine that an adjustment to the at least one audio output device in use is required to enhance viewing experience. The spatial audio directing system may determine that since a user is viewing content to their left then audio should be received from left as well. This may result in the spatial audio directing system deactivating the at least one speaker present at the right side of the laptop 1 and providing audio media data strictly from the at least one speaker present on the left side of the laptop 1. The highlighted area on laptop 1 describes where sound associated with the content present on external monitor 2 may be provided from.

Referring now to FIG. 4B, a system including two monitors and a traditional laptop speaker setup is provided. In this system, a laptop “3” may include a display integrally coupled to the system and a traditional speaker setup also integrally coupled to the system. This speaker setup includes at least one speaker present on the left and right sides of the keyboard. An external monitor “4” in operatively coupled to the system. Upon connection of the external monitor 4 to the laptop 3, a spatial audio directing system may receive external display data and may further determine a location of the external monitor 4 in comparison to the laptop 3, and/or an origin device. The spatial audio directing system may determine that the external monitor 4 is located to the right of the laptop 3.

A user may then access a virtual meeting through an application present on the information handling device. After activating an application on the laptop 3, the application may open on the display of laptop 3. At this instance, the spatial audio directing system may determine that any audio media data associated with content being viewed, for example, the virtual meeting application, may be supplied in a traditional manner from both speakers present on each side of the laptop 3. Here a user’s attention is determined to be directed to the display of the laptop 3. Then, as a user transitions a location of the application of the virtual meeting from the display of laptop 3 to the external monitor 4, the spatial audio directing system may determine that a location the content has been repositioned and user position data has been adjusted because the repositioning of content to a new display. In response to this transition of location of content, the spatial audio directing system may determine that an adjustment to the at least one audio output device in use is required to enhance viewing experience. The spatial audio directing system may determine that since a user is viewing content to their right then audio should be received from the right as well. This may result in the spatial audio directing system deactivating the at least one speaker present at the left side of the laptop 3 and providing audio media data strictly from the at least one speaker present on the right side of the laptop 3. The highlighted area on laptop 3 describes where sound associated with the content present on external monitor 4 may be provided from.

As another example, a system including a single monitor and four audio output devices coupled to an information handling device may be utilized by a user to view content. A single monitor may be a standard size external monitor (e.g., a 24-inch monitor), an oversized monitor (e.g., 46-inch monitor), and/or the like. The single monitor may be segmented into four (4) equal-sized sections on a display of the monitor. Additionally, the four output devices are external of the information handling device and are located at the four corners of a wall the display is located on. For example, a television that is mounted on a wall that has surround-sound speakers present at each corner. After activating an application to view content, a user may elect to view the content across the entirety of the screen. This displaying of content may utilize all four audio output devices (e.g., speakers) simultaneously. Then, a user may elect to position the application being viewed by the user over the left two quadrants of a display, taking up the left-half of the display. In the system and resultant of this transition of the location of content on a display, the spatial audio directing system may determine the audio output devices consistent with the new position of the content on the display may remain active, for example, the two (2) speakers located to the left of the display, and the audio output devices inconsistent with the new position of the content, and/or located away from where a user is viewing content, may become inactive.

The position of the content of the left-half of the display may be repositioned once more to move from occupying the left two quadrants of the display to downsizing and only occupying the top-left quadrant of the display. The spatial audio directing system may identify this transition in location of content and adjust active audio outputting devices accordingly. The new position of the application including the content on the display may include deactivating an audio output device, for example, the lower-left speaker that is consistent in direction with the lower-left quadrant of the display, and maintaining an audio output device associated with the new position, for example, top-left speaker consistent with top-left quadrant of the display.

As an additional example, a system including multiple displays, for example, four (4) monitors, and multiple audio output devices, for example, eight (8) speakers, may be coupled to an information handling device utilized by a user. Each display may be located at a position that also includes two speakers. In other words, each monitor has two speakers within a threshold distance from each other. Upon activation of an application at the information handling device, the user may position the application presenting content on monitor 1. The spatial audio directing system may determine that two speakers at the same location as monitor 1, speaker 11 and speaker 12, are orientated to the user viewing the content, and thus, both speakers may provide audio media data of the content to the user. While content is being provided to a user via the active application, the user may elect to reposition the application to monitor 3, and based upon the transition of location of content being displayed in a system, the audio output devices consistent with the display previously displaying the content, speaker 11 and speaker 12, may then be deactivated, and the spatial audio directing system may determine at least one new audio output device for supplying the audio media data. Monitor 3 is located next to two audio output devices, speaker 31 and speaker 32. The spatial audio directing system may determine that the orientation for audio projection for speaker 31 is towards a user viewing content present on monitor 3, and may also determine that orientation for audio projection for speaker 32 is in the opposite direction. Therefore, based on the orientations of the audio output devices, the spatial audio directing system may determine that speaker 31 can be supply the audio media data to the user, but speaker 32 cannot.

In the system, as content continues to be displayed on monitor 3 and audio media data being provided from speaker 31, the user elects to activate a second application that may provide content to a user. Upon this application activation, monitor 2 may display the new content, and the spatial audio directing system may determine that the two audio output devices in the same location, speaker 21 and speaker 22, are consistent in direction with monitor 2. Now, in the system, monitor 2 and speakers 21 and 22 are providing the new content to a user while monitor 3 and speaker 31 is supplying the original content to the user. Rather than the audio media data of each piece of content battling over what can be supplied to a user, the system may provide both audio streams and their accompanying visual content to a user at a single information handling device.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
receiving, at a spatial audio directing system, an indication to output a sound at one of a plurality of audio output devices, wherein the sound is associated with content of an information handling device;
determining, utilizing the spatial audio directing system, a location of the content on the information handling device and with respect to a position of the user; and
outputting, utilizing the spatial audio directing system, the sound at an audio output device corresponding to the location of the content with respect to the position of the user.

2. The method of claim 1, wherein the outputting comprises identifying a location of a plurality of audio output devices with respect to the location of the content and selecting the audio output device from the plurality of audio output devices that correlates to the location of the content with respect to the position of the user.

3. The method of claim 1, comprising detecting movement of the information handling device and selecting a new audio output device for the outputting of the sound in view of the movement.

4. The method of claim 3, wherein the detecting of the movement and the selecting of the new audio output device is performed in real-time as the movement is detected.

5. The method of claim 1, comprising detecting movement of the content on the information handling device and selecting a new audio output device for the outputting of the sound in view of the movement.

6. The method of claim 1, wherein the information handling device comprises an information handling device in operative communication with a second device;
wherein the determining comprises determining a location of the information handling device with respect to the second device; and
wherein the outputting comprises selecting an audio output device of the second device closest to the information handling device.

7. The method of claim 6, comprising detecting movement of the information handling device with respect to the second device and selecting a new audio output device for the outputting of the sound in view of the movement.

8. The method of claim 1, wherein the determining comprises identifying the sound is associated with an application present on a display and wherein the determining the location of the content with respect to the position of the user is performed in view of the location of the application.

9. The method of claim 1, wherein determining a position of a user comprises utilizing at least one sensor coupled to the information handling device;
wherein the at least one sensor collects user position data.

10. The method of claim 1, wherein determining a position of a user comprises detecting a location of a gaze of the user.

11. A system, the system comprising:
a processor;
a memory device that stores instructions that, when executed by the processor, causes the device to:
receive, at a spatial audio directing system, an indication to output a sound at one of a plurality of audio output devices, wherein the sound is associated with content of an information handling device;
determine, utilizing the spatial audio directing system, a location of the content on the information handling device and with respect to a position of the user; and
output, utilizing the spatial audio directing system, the sound at an audio output device corresponding to the location of the content with respect to the position of the user.

12. The system of claim 11, wherein the outputting comprises identifying a location of a plurality of audio output devices with respect to the location of the content and selecting the audio output device from the plurality of audio output devices that correlates to the location of the content with respect to the position of the user.

13. The system of claim 11, comprising detecting movement of the information handling device and selecting a new audio output device for the outputting of the sound in view of the movement.

14. The system of claim 13, wherein the detecting of the movement and the selecting of the new audio output device is performed in real-time as the movement is detected.

15. The system of claim 11, comprising detecting movement of the content on the information handling device and selecting a new audio output device for the outputting of the sound in view of the movement.

16. The system of claim 11, wherein the information handling device comprises an information handling device in operative communication with a second device;
wherein the determining comprises determining a location of the information handling device with respect to the second device; and
wherein the outputting comprises selecting an audio output device of the second device closest to the information handling device.

17. The system of claim 16, comprising detecting movement of the information handling device with respect to the second device and selecting a new audio output device for the outputting of the sound in view of the movement.

18. The system of claim 11, wherein the determining comprises identifying the sound is associated with an application present on a display and wherein the determining the location of the content with respect to the position of the user is performed in view of the location of the application.

19. The system of claim 11, wherein determining a position of a user comprises utilizing at least one sensor coupled to the information handling device;
wherein the at least one sensor collects user position data.

20. A product, the product comprising:
a computer-readable storage device that stores code that, when executed by the processor, causes the product to:
receive, at a spatial audio directing system, an indication to output a sound at one of a plurality of audio output devices, wherein the sound is associated with content of an information handling device;
determine, utilizing the spatial audio directing system, a location of the content on the information handling device and with respect to a position of the user and
output, utilizing the spatial audio directing system, the sound at an audio output device corresponding to the location of the content with respect to the position of the user.
